(19) United States
(12) Patent Application Publication
(10) Pub. No.: US 2003/0132594 A1
(43) Pub. Date: Jul. 17, 2003

(54) Valve arrangement for controlling an air suspension, a valve unit, and a vehicle provided with such devices

(75) Inventor: James Den Hartog, Alingsas (SE)

Correspondence Address: HOWREY SIMON ARNOLD & WHITE LLP, 1299 PENNSYLVANIA AVE., NW, BOX 34, WASHINGTON, DC, 20004, US

(73) Assignee: Volvo Lastvagnar AB, Goteborg (SE)

(21) Appl. No.: 10/065,830

(22) Filed: Nov. 22, 2002

Related U.S. Application Data
(63) Continuation of application No. PCT/SE01/01177, filed on May 25, 2001.

(30) Foreign Application Priority Data
May 25, 2000 (SE) 0001952-1

(51) Int. Cl. B60G 11/26

(52) U.S. Cl. 280/124.16

(57) ABSTRACT

Valve arrangement for multi-axle vehicles having air suspension, which vehicle is provided with at least one axle (1, 2, 3) having two or more air suspension elements (4,5, 6,7, 8, 9, 30) which can be pressurized by means of a source of compressed air (10), valves (13,14,15,16,17,18) for pressurizing or venting said air suspension elements, and a control unit (25) for controlling opening and closing of said valves. A valve unit can also be provided for each air suspension element, which valve unit comprises a first valve (15a, 16a, 44) between the source of compressed air (10) and the air suspension element (4, 5,6,7,8, 9, 30), for pressurizing said air suspension element, and a second valve (15b, 16b, 49) connected between the first valve and the air suspension element, for venting said air suspension element, which valves are normally closed. The invention further relates to a valve unit for said valve arrangement and a vehicle provided with such a valve arrangement.

### CROSS REFERENCE TO RELATED APPLICATIONS

This application is a continuation patent application of International Application No. PCT/SE01/01177 filed May 25, 2001 which was published in English pursuant to Article 21(2) of the Patent Cooperation Treaty, and which claims priority to Swedish Application No. 0001952-1, filed May 25, 2000. Both applications are expressly incorporated herein by reference in their entireties.

### BACKGROUND OF INVENTION

1. Technical Field

The invention relates to a valve arrangement for vehicles provided with air suspension, a valve unit for such an arrangement and a vehicle provided with such a valve arrangement.

2. Background Art

Vehicles with air suspension are usually provided with a pair of air suspension elements, such as bellows, for each suspended axle. The volume of the air suspension elements can be varied with respect to the load on the vehicle or the height relative to the vehicle frame or ground-level. A conventional method of achieving this is to connect each air suspension element to a pair of valves, of which one valve is used for pressurizing and one is used for venting the air suspension element.

A valve arrangement for a vehicle having four bellows is disclosed in WO-A 1-9305972. The disclosed purpose of this arrangement is to minimize the number of valves in the system, since multiple valves often involve a complex control system. A disadvantage of this system is that all of the valves have been assembled into a single valve block or valve manifold. In present day vehicles, such valve blocks are often heavy and very complex structures. In order to avoid too many connections, with corresponding conduits between the individual valves, these components have been assembled into compact units. The different units making up a valve block will therefore comprise several different valves, each with its own specific function. As disclosed in WO-A 1-9305972, the different valves are connected to a central manifold chamber that can be pressurized or vented, which makes it impossible to pressurize one of the bellows at the same time as another is being vented.

A similar system is disclosed in DE-A1-38 15 612. In this document, FIG. 1 shows a valve block 20 that has three valves. This valve block 20 controls the air suspension for one axle. The complex structure of a valve block is not apparent from schematic figures of this type, however, a cross-section of an actual valve block of this type is shown in FIG. 1 of DE-A1-38 15 612. Using the figure and reference numbers of DE-A1-38 15 612, FIG. 1 shows three solenoid valves 25-27 provided with plungers. A first valve 25 is normally connected to the atmosphere, but is also provided with a connection 21 to a pressure source. The remaining two valves 26, 27 are normally closed, but may be connected to their respective bellows via the connections 31 and 32 respectively, for venting the bellows. As in the previous case, it is not possible to pressurize one bellows while venting the other. The unit of DE-A1-38 15 612 is further provided with a connection 29, which may be connected to further units in the valve block. For simplicity, the function of the valves will not be described in detail.

Hence, a problem with current solutions is that the valve blocks are heavy, complex, and therefore expensive components. In addition, each valve block itself contains a number of units including complex and often specially designed valves, each with its own specific function.

Repairing or replacing one or more units in a valve block will therefore give rise to further problems. Apart from the complexities of the replacement, it is also necessary for the workshop in question to have one or more specific valve units in stock. As each model of a vehicle is usually provided with two or more different valve units, which may vary in design both between different models and within a model series, even a branded garage will need to keep a large number of different units in stock.

### SUMMARY OF INVENTION

One purpose of the invention is to provide a valve unit that can replace different types of valve units used in current air suspensions. A valve unit configured according to the invention can be installed separately in proximity to each air suspension element on every axle, or centrally in a valve block. By using identical valve units, installed separately or in combination, service and replacement of parts will be significantly simplified. In the long term, the effect will be that only one kind of valve unit needs to be kept in stock with retail dealers and garages.

In at least one embodiment, the present invention relates to a valve arrangement for vehicles having two or more axles with air suspension. Such a vehicle normally includes at least one axle that is provided with two or more air suspension elements that can be pressurized by means of a source of compressed air, together with valves for pressurizing or venting the air suspension element, and a control unit for controlling the opening and closing of the valves. Each air suspension element has a first valve connected between the source of compressed air and the air suspension element and a second valve connected between the first valve and the air suspension element for venting the air suspension element. Both of these valves are normally closed.

By means of this arrangement, it is possible to control all valves separately, which enables complete individual control. This is particularly suitable for such vehicles as buses having a lowering function in which lowering of one side, or alternatively one corner of the vehicle is required. Since a single valve according to the invention can replace a lowering valve that typically may comprise six or more valves, a significant cost reduction and simplification of the system is achieved.

The first and second valves are advantageously of the same type and are preferably, but not necessarily, assembled to a valve unit. This combination of the first and second valves is preferably used for all air suspension elements of the vehicle. By using identical valves for all air suspension elements, the structure of the system is significantly simplified. Apart from making service and replacement of parts simpler and quicker, only one type of valve has to be kept in stock. The valve units can either be installed adjacent each of the respective air suspension elements or be assembled in a central valve block.

In order to allow for simple maneuvering of the valve units, using for instance a central control unit, a suitable type of valve for this purpose are those of the solenoid-type.

In contrast to current valve units using slide valves, the preferred valves according to the present invention are diaphragm valves. Diaphragm valves weigh less, are easier to manufacture and maintain, and are often more reliable than conventional slide valves.

A valve unit used in the valve arrangement is principally meant for use in connection with air suspension elements in a vehicle, but may also be used in other kinds of compressed air systems. An exemplary valve unit according to the present invention includes a valve body with a connection from a source of compressed air and a connection to a compressed air consumer, as well as a connection for venting the compressed air consumer. Further, the valve unit is provided with a first valve between the source of compressed air and the compressed air consumer, and a second valve for venting the compressed air consumer. Both valves are normally in a closed position.

Each valve is provided with a solenoid for individual opening of either valve using an electronic control unit. The opening of both valves simultaneously is prevented, as this would mean venting the source of compressed air. Venting of an air suspension element using the second valve is suitably done to the atmosphere.

In order to achieve further weight savings, the valve body can be made from a plastic material. In addition, an injection molded valve body is more simple to manufacture and requires less subsequent machining than a corresponding body made from a metallic material.

### BRIEF DESCRIPTION OF DRAWINGS

FIG. 1 shows a schematic cross-section of a conventionally designed valve unit;

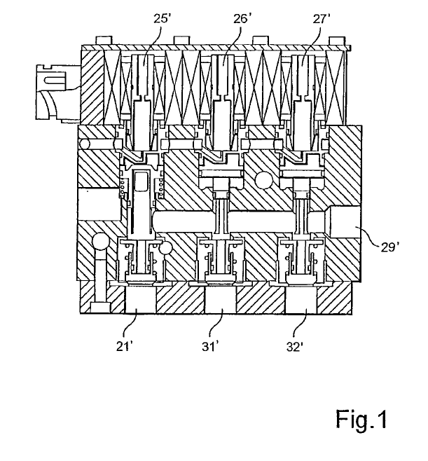

FIG. 2 shows a schematic diagram for an embodiment of the present invention including a vehicle with three axles;

FIG. 3 shows a schematic diagram for the driving axle from FIG. 2;

FIG. 4 shows a schematic representation of a valve unit with two valves arranged according to the invention;

FIGS. 5a and 5b show schematic cross-sections of a valve unit with two valves configured according to the invention.

### DETAILED DESCRIPTION

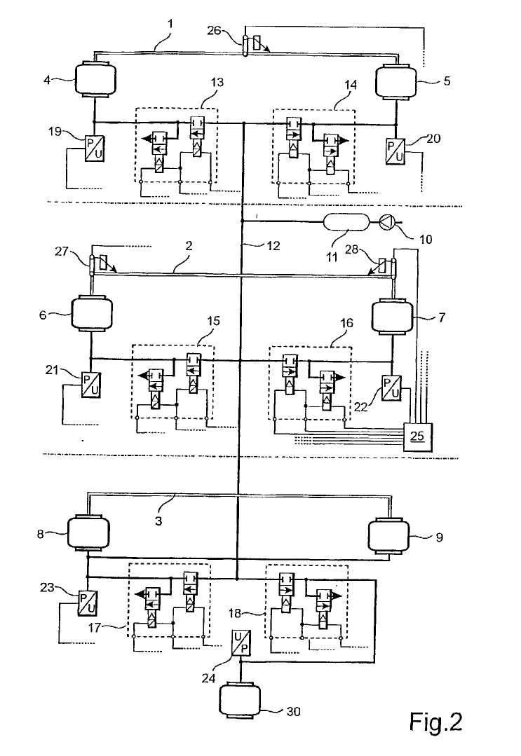

FIG. 2 shows a schematic diagram for an embodiment intended for a vehicle with three axles; a front axle 1, a driving axle 2 and a further axle 3. In this case, the invention is intended for a heavy vehicle in the form of a tractor unit with one driving axle, and may be applied to the front axle, the driving axle and the further axle or on all three axles. Other combinations, for instance using several driving axles, are of course possible. Common for all embodiments is that one type of valve unit can be used for all axles with air suspension.

The air suspension is achieved by means of air suspension elements in the form of bellows. According to the embodiment of FIG. 2, all axles 1, 2, 3 are provided with bellows 4, 5; 6, 7; 8, and 9 arranged in pairs on each axle. The bellows are placed between the chassis of the vehicle and each respective wheel axle. By controlling the pressurization or venting of the bellows, it is possible to achieve a desired height above ground level or to control the pressure difference between two bellows on the same axle. In this way, the vehicle may, for instance, be raised when traveling on an uneven surface and be lowered when traveling on a motorway, when disengaging a trailer or when adjusting the height to a loading bay. It may also be desirable to control the pressure so that the driving axle takes a larger load than the bogie axle in order to improve the gripping power of the tires. The term bogie axle denotes a first driving axle that can be combined with a further axle, such as a lifting axle, a trailing axle, a second driving axle or a pusher axle.

According to the invention, a source of compressed air 10 delivers a pressure to an accumulator 111 that is connected to a supply conduit 12. The supply conduit 12 supplies a number of valve units 13, 14; 15, 16; 17, and 18 which are in turn connected to a corresponding number of bellows 4, 5; 6, 7; 8, and 9. Each bellows is provided with a pressure sensor 19, 20; 21, 22; 23, and 24 for measuring the pressure in the respective bellows, and for transmitting signals corresponding to the pressure levels to a control unit 25. The bellows of the further axle 3 is controlled by a single valve unit 17. As the pressure in these bellows is equal, it can be measured by a single pressure sensor 23.

In addition, the front axle 1 and the driving axle 2 are provided with level sensors 26; 27, and 28 that measures the distance between the bellows and the chassis. As the front axle 1 carries less load, it is only provided with a single level sensor 26 between the bellows 4 and 5. The driving axle that takes up a considerably larger load is provided with level sensors 27 and 28 on either side of the vehicle adjacent to each bellows. Signals representing the distance between chassis and axle are sent from the level sensors 26; 27, and 28 to the control unit 25.

The further axle 3 lacks a level sensor, as it only takes up that part of the load that can not be taken up by the driving axle 2. The further axle, however, is provided with an additional bellows 30 in order to lift the axle when required; for example. to the turning radius of the tractor unit and/or to reduce wear on the tires. This bellows is controlled by a separate valve unit 18.

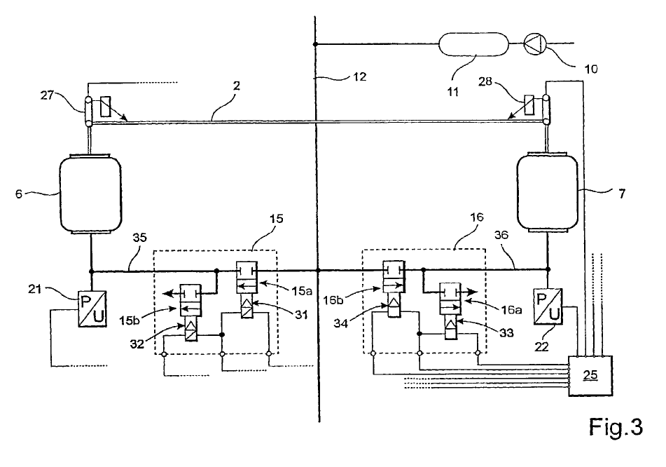

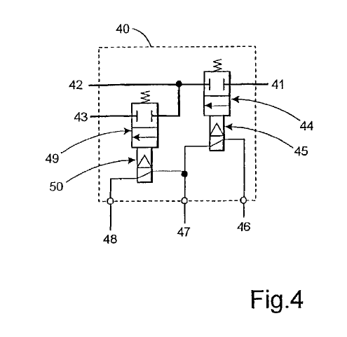

The function of the valve units and the wiring of the sensors to the control unit 25 will now be described in detail, with reference to FIGS. 3 and 4.

FIG. 3 shows a selected section of FIG. 2, including the driving axle 2 only. When the pressure in a bellows 6, 7 needs to be adjusted, the control unit 25 evaluates the signals from the pressure sensors 21, 22 and the level sensors 27, 28. Should a situation occur requiring an increased pressure in the left bellows 6 of the driving axle 2, then a signal is transmitted from the control unit 25 to the valve unit of that bellows 6. The signal actuates a solenoid 31 in the valve 15a of the valve unit 15 connecting the source of compressed air 10 with the bellows 6. This valve 15a includes a normally closed two-position valve, which is caused to open by means of the solenoid in order to pressurize the bellows 6. Upon achieving the desired pressure level, the control unit 25 will cut the current to the solenoid 31 and the valve 15a will close. The pressure level is monitored by the control unit 25 by means of the pressure sensor 21. The same method can be used for raising the vehicle using the bellows 6 and 7. In this case the control unit 25 will also use the level sensors 27 and 28 when opening and closing the valves 15a and 16a of the respective valve units.

In order to vent either of the bellows 6 and 7, or to lower the vehicle, a pair of second valves 15b and 16b in the respective valve units are used. These valves are connected to the conduits 35 and 36, respectively, between the above first valves 15a and 16a and the bellows 6 and 7 respectively. The control unit 25 transmits a signal to the solenoids 32 and 34 of one or both valves 15b and 16b in order to open said valves, whereby one or both bellows 6 and 7 are vented. Lowering the vehicle by venting the bellows is desirable, for instance, when the vehicle is traveling at higher speeds, or when depositing or picking up a trailer, an exchangeable platform or a container.

An advantage over current systems that the present invention affords is that it makes it possible to control all bellows individually and simultaneously. It is, for instance, possible to pressurize a bellows on one side of the vehicle at the same time as the bellows on the opposite side is being vented. Since only one valve needs to be controlled to pressurize or vent the bellows, the system gives a faster response to signals from the control unit. In addition to common control strategies for controlling the pressure in the bellows, a system of this type allows rapid pressurization of one side combined with venting of the opposite side in order to achieve a temporary displacement of the center of gravity to counteract or prevent the vehicle from overturning.

It is also possible to raise or lower one side or one corner of the vehicle through individual control of the bellows in connection to the respective side or corner. This is desirable for buses having a lowering function, whereby the height of the instep is controlled by raising or lowering the section of the vehicle adjacent to the door. During boarding, it is possible, for instance, to lower (deflate or shrink) a bellows associated with the front corner of the bus in order to reduce the height of the step.

FIG. 4 shows a schematic representation of a valve unit configured according to the invention. The valve unit 40 is provided with a connection 41 to the source of compressed air, a connection 42 to a bellows and a connection 43 for venting to a tank or to the atmosphere. The first valve 44 is spring loaded towards a closed position, but can be moved to an open position for pressurization of the bellows by means of a solenoid 45. The solenoid is controlled by a control unit (not shown) by means of a pair of connective electrical wires 46 and 47. When the current to the solenoid is interrupted by the control unit, the valve 44 will close. A second valve 49 of the same type as the first valve 44 is connected to a conduit between the first valve 44 and the connection 42 to the bellows. The second valve 49 is also spring loaded towards a closed position, but can be moved to an open position by means of a solenoid 50. The solenoid 50 is connected to the control unit by means of a pair of electrical wires 47 and 48 wherein one of the wires 47 is a ground connection that is used in common with the first solenoid 45. When a signal is transmitted from the control unit, the second valve 49 opens to vent the bellows.

It is of course possible to use the wire 47 for positive or negative feeding of the solenoids.

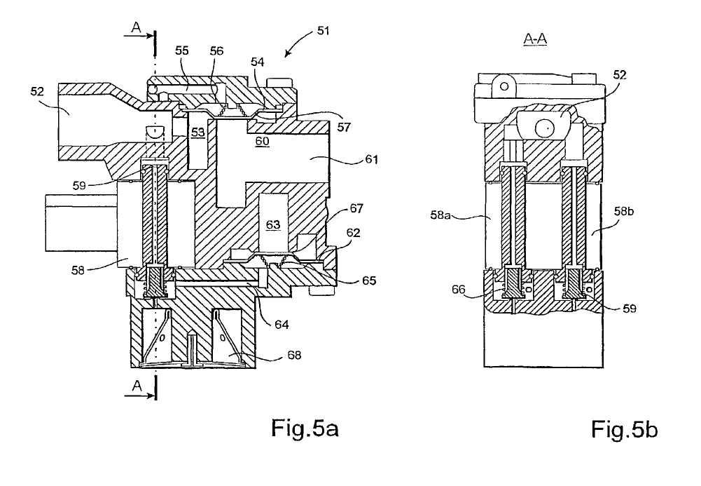

A schematic cross-section of a valve unit that can be used in a system according to the invention is shown in FIGS. 5a and 5b.

FIG. 5a shows a valve unit 51 that is provided with a connection 52 for compressed air which discharges into a first chamber 53 on one side of a diaphragm valve 54. Compressed air from the connection 52 is conducted through a first conduit 55 to the opposite side of said diaphragm valve 54. Hence, the pressure is equal on both sides of the valve 54, which is provided with a spring 56 for spring loading the valve 54 against a seat 57. In this way, the valve is normally in a closed position.

In order to open the diaphragm valve 54, a first solenoid 58a (FIG. 5b) is used, which when actuated will act on a piston 59 that closes the connection between the source of compressed air 52 and the first conduit 55. The pressure in the first chamber 53 will cause the diaphragm valve 54 to lift from the seat 57 against the returning force of the first spring 56 only. Pressurized air will then flow from the first chamber 53, past the first diaphragm valve 54, into a second chamber 60, and out through a connection 61 to the bellows to be pressurized. As soon as the current to the first solenoid 58a is interrupted, the pressure is restored in the first conduit 55. With an equalized pressure on both sides of the diaphragm in the first valve 54, the valve will be closed by the return spring 56.

The valve unit 51 is provided with a second diaphragm valve 62, which has a similar function for venting the bellows. The connection 61 to the bellows leads into the second chamber 60 and further into a third chamber 63 on one side of the second diaphragm valve 62. The connection for pressurized air 52 is connected via a second solenoid 58b to a conduit 64 that exits on the opposite side of the valve 62. As the pressure is equal on both sides, alternatively somewhat larger in the conduit 64, the diaphragm valve 62 is held in a closed position by the pressure and/or a spring 65. In order to vent the bellows a second solenoid is used, which when actuated will act on a piston 66 that closes the connection between the connection 52 and the conduit 64. The conduit 64 is then vented to the atmosphere via a silencer 68. The pressure in the third chamber 63 will then cause the diaphragm of the valve to lift from its seat 67, whereby pressurized air will flow past the valve 62 via a conduit (not shown) that is vented to the atmosphere through an outlet that exits in the silencer 68.

It is also possible to lead pressurized air from the bellows from the chamber 60 via the second solenoid 58b to the conduit 64 (connection not shown). The air pressure on both sides of the second diaphragm valve 62 will then be equalized, until the solenoid 58b is activated for venting of the bellows.

A suitable valve for this purpose can be a standard valve used for anti-locking pneumatic brakes (ABS). An ABS-valve can be modified by reversing one of its solenoids and by re-boring/machining certain conduits and seats. This is done to achieve a normally closed valve, as the original valve is normally open. By starting from a valve unit having a valve body that after minor modifications can be used for multiple purposes, several advantages are achieved in view of rationalization and reduced costs.

In the above, the valve unit has been described in connection with valve arrangements for air suspension for vehicles. It is of course possible to use the valve unit for compressed air systems having different applications.

1. Valve arrangement for multi-axle vehicles having air suspension, which vehicle is provided with at least one axle having two or more air suspension elements which can be pressurized by means of a source of compressed air, valves for pressurizing or venting said air suspension elements, and a control unit for controlling opening and closing of said valves, each air suspension element is provided with a first valve between the source of compressed air and the air suspension element, for pressurizing said air suspension element, and a second valve connected between the first valve and the air suspension element, for venting said air suspension element, which valves are normally closed.

2. The valve arrangement as recited in claim 1, wherein said first and second valves are of the same type.

3. The valve arrangement as recited in claim 1, wherein said first and second valves are attached together into a single valve unit.

4. The valve arrangement as recited in claim 1, wherein said valve unit comprising a combination of the first and the second valves is used for all air suspension elements in the vehicle.

5. The valve arrangement as recited in claim 1, wherein said valve units are mounted adjacent its respective air suspension element.

6. The valve arrangement as recited in claim 1, wherein said valves are mounted together in a valve block.

7. The valve arrangement as recited in claim 1, wherein said valves are solenoid valves.

8. The valve arrangement as recited in claim 1, wherein said valves are diaphragm valves.

9. The valve arrangement as recited in claim 1, wherein said second valve is vented to the atmosphere.

10. A valve unit for use in a pneumatic system, which unit comprises a valve body with a connection to a source of compressed air, a connection compressed air consumer, and an outlet for venting of the compressed air consumer, the valve unit has a first valve, for pressurization, between the source of compressed air and compressed air consumer, and a second valve, for venting, connected between the first valve and the compressed air consumer, wherein both valves are normally closed.

11. The valve arrangement as recited in claim 10, wherein each of said valve is provided with a solenoid for individual opening of either valve.

12. The valve arrangement as recited in claim 10, wherein said valves are diaphragm valves.

13. The valve arrangement as recited in claim 10, wherein said second valve is vented to the atmosphere.

14. The valve arrangement as recited in claim 10, wherein said valve body is made from a plastic material.

15. A vehicle with air suspension comprising valve arrangements for multi-axle vehicles having air suspension, which vehicle is provided with at least one axle having two or more air suspension elements which can be pressurized by means of a source of compressed air, valves for pressurizing or venting said air suspension elements, and a control unit for controlling opening and closing of said valves, each air suspension element is provided with a first valve between the source of compressed air and the air suspension element, for pressurizing said air suspension element, and a second valve connected between the first valve and the air suspension element, for venting said air suspension element, which valves are normally closed; and
the vehicle having at least one axle provided with two or more air suspension elements which can be pressurized by means of a source of compressed air, valves for pressurizing or venting said air suspension element, and a control unit for controlling opening and closing of said valves, characterized in that each air suspension element is provided with said valve arrangement, which valves can be pressurized or vented individually and independently of each other by the control unit.

16. The vehicle as recited in claim 15, wherein one or more valve arrangements on one side of the vehicle can be controlled to achieve a lowering function.
